(19) United States
(12) Patent Application Publication
(10) Pub. No.: US 2012/0159756 A1
(43) Pub. Date: Jun. 28, 2012

(54) Press tool with a biased jaw

(75) Inventor: Lei Zhang, Tianjin (CN)

(73) Assignee: LINK-TECH (TIANJIN) METAL PRODUCTS CO., LTD.

(21) Appl. No.: 12/984,578

(22) Filed: Jan. 4, 2011

(30) Foreign Application Priority Data
Dec. 27, 2010 (CN) 201020682053.3

(51) Int. Cl. B23P 19/04

(52) U.S. Cl. 29/237

(57) ABSTRACT

A press tool with a biased jaw, includes: a clamp head portion and a clamp handle portion connected with the clamp head portion. The clamp head portion includes a fixed clamp head and a movable clamp head. The clamp head portion includes a fixed clamp handle and a movable clamp handle. The fixed clamp handle is fixedly connected with the fixed clamp handle. The movable clamp head is movably connected with the movable clamp handle via a pin and a guiding wheel. The movable clamp head has a guiding groove for guiding the guiding wheel. The fixed clamp head is rotatably connected with the moving clamp head via a rotating pin. The fixed clamp head is connected with the movable clamp handle via an eccentric shaft. The fixed clamp handle is connected with the movable clamp handle via a tension spring.

### BACKGROUND OF THE PRESENT INVENTION

1. Field of Invention

The present invention relates to a hardware tool, and more particularly to a press tool with a biased jaw.

2. Description of Related Arts

Press tools are widely used in pipeline connection, cable connection, and so on. Plastic tubing, such as water pipe, and pipe fittings, such as two way connector and three way connector, mostly utilize corresponding copper ring to connect. When connecting the tubings and the pipe fittings, they are connected by inserting connection, the corresponding rings are mounted on the outer wall of the tubings or the fittings, and then a special clasp forceps is used to pressing the rings and decrease their diameters to connect the tubings and the pipe fittings tightly. A conventional press tools mainly consists of a clamp head and a clamp handle. The left clamp head and the right clamp head are connected via cover boards of two sides. The clamp mouth has a semicircular mouth module for pressing the copper rings. When using, by operating the clamp handle to open the clamp mouth, holding the connection ring into the mouth module, and then pressing the ring with the clamp handle, the diameter of the ring is decreased, and the tubings and the pipe fittings are connected tightly.

However, regarding to the above press tool, the clamp head and the clamp handle are in same axis direction, so that it can not be or too hard to be used under some work circumstances. In addition, a tool can only be used to press a certain pipe fitting or cable, therefore reducing quality of the whole project and construction efficiency.

### SUMMARY OF THE PRESENT INVENTION

An object of the present invention is to provide a press tool for pressing both pipe fittings and cables, which has simple structure and laborsaving operation.

Another object of the present invention is to provide a press fool with a biased jaw, which utilizes the guiding wheel and the guiding groove to drive the movable clamp head by the movable clamp handle, has stable and simple structure, reduces weight and cost.

Accordingly, in order to accomplish the above objects, the present invention provides a press tool with a biased jaw, comprising:
a clamp head portion, comprising a fixed clamp head and a movable clamp head; and
a clamp handle portion connected with the clamp head portion, comprising a fixed clamp handle and a movable clamp handle,
wherein the fixed clamp handle is fixedly connected with the fixed clamp handle, the movable clamp head is movably connected with the movable clamp handle via a pin and a guiding wheel, wherein the movable clamp head has a guiding groove for guiding the guiding wheel, the fixed clamp head is rotatably connected with the moving clamp head via a rotating pin, the fixed clamp head is connected with the movable clamp handle via an eccentric shaft, the fixed clamp handle is connected with the movable clamp handle via a tension spring.

Preferably, the present invention can be embodied as follows.

The guiding groove in the movable clamp head is curved to adapt for different sizes of different pipe fittings or cables being pressed..

The clamp head portion further comprises a module for pressing a cable.

The module in the clamp head portion is detachable and replacable.

The fixed clamp head further comprises a retaining boss therein, and a shore at an edge thereof.

The movable clamp head comprises two bosses for preventing swinging on two outer sides thereof respectively.

The fixed clamp handle and the movable clamp handle have U-shaped sections and comprise clamp handle gloves respectively.

Therefore, the clamp head portion utilizes the moving structure that the guiding wheel rolls in the guiding groove, which has simple structure and low weight, is convenient to open, laborsaving to use, and easy to operate. The press tool according to the present invention can not only be used to press pipe fittings but also cables, and will not be affected by work circumstances, so as to greatly increase construction efficiency and engineering quality.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a press tool with a biased jaw according to a first preferred embodiment of the present invention.

FIG. 2 is an exploded view of the press tool with a biased jaw according to the first preferred embodiment of the present invention.

FIG. 3 is a perspective view of a fixed clamp head of the press tool with a biased jaw according to the first preferred embodiment of the present invention.

FIG. 4 is a perspective view of a movable clamp head of the press tool with a biased jaw according to the first preferred embodiment of the present invention.

FIG. 5 is a perspective view of a press tool with a biased jaw according to a second preferred embodiment of the present invention.

Wherein, 1, clamp head portion; 1-1, fixed clamp head; 1-2, movable clamp head; 1-3, rotating pin; 1-4, eccentric shaft; 1-5, fixing pin; 1-6, opening block ring; 1-7, retaining boss; 1-8, shore; 1-9, guiding groove; 1-10, boss; 1-11, second mounting hole; 1-12, third mounting hole; 1-13, fixing hole; 1-14, fourth mounting hole; 2, clamp handle portion; 2-1, fixed clamp handle; 2-2, movable clamp handle; 2-3, guiding wheel; 2-4, pin; 2-5, tension spring; 2-6, fixed clamp handle glove; 2-7, movable clamp handle glove; 2-8, tension spring fixed leg; 2-9, first mounting hole; 2-10, fifth mounting hole; 3, module.

### DETAILED DESCRIPTION OF THE PREFERRED EMBODIMENT

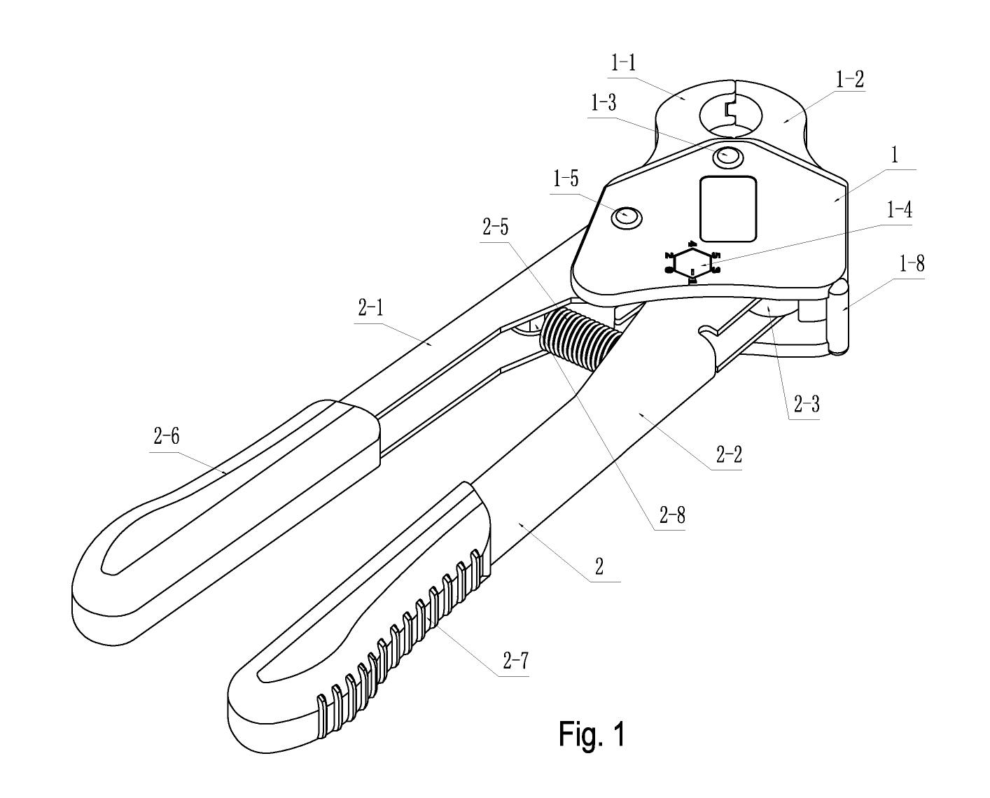

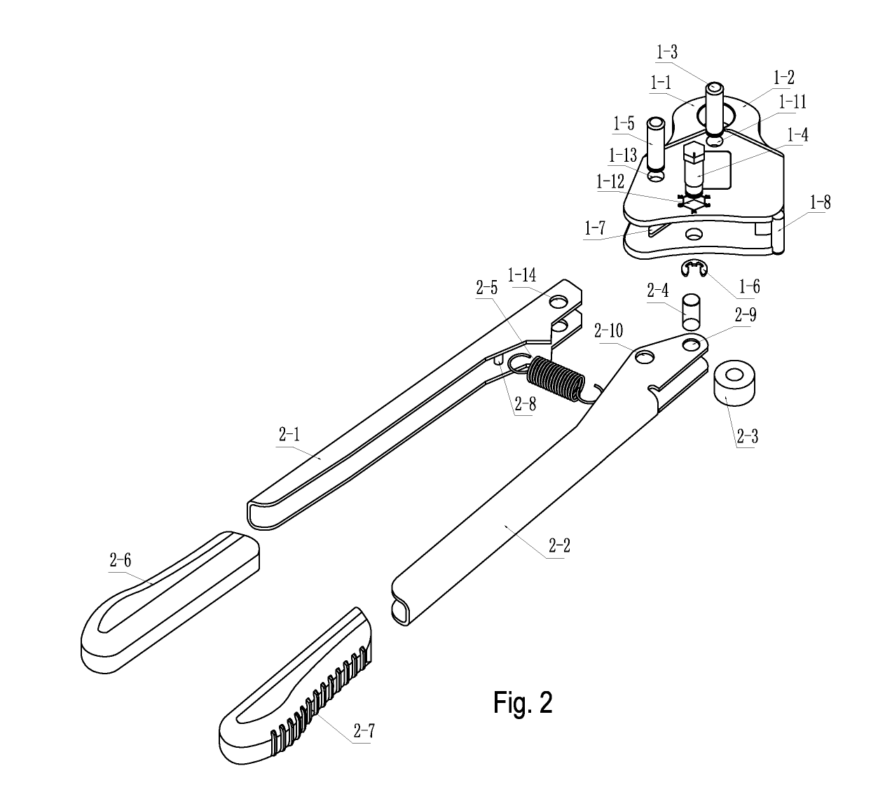

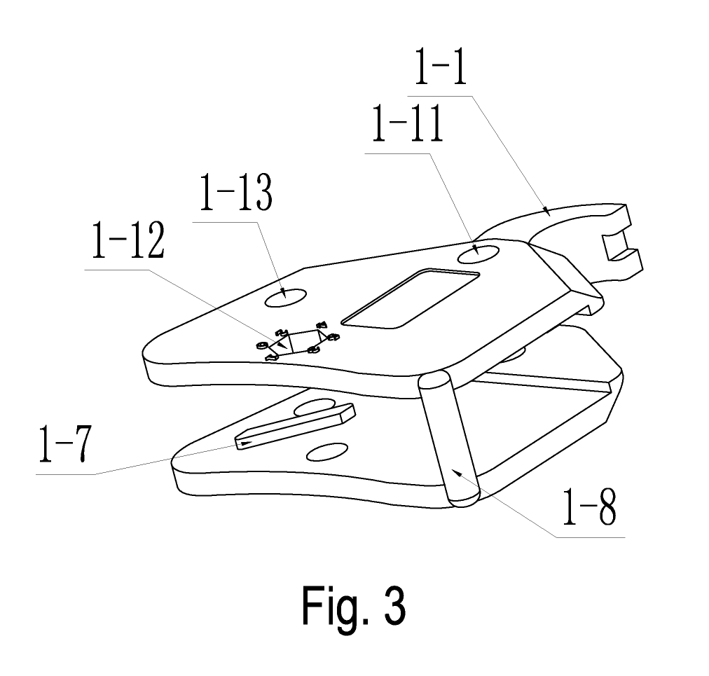

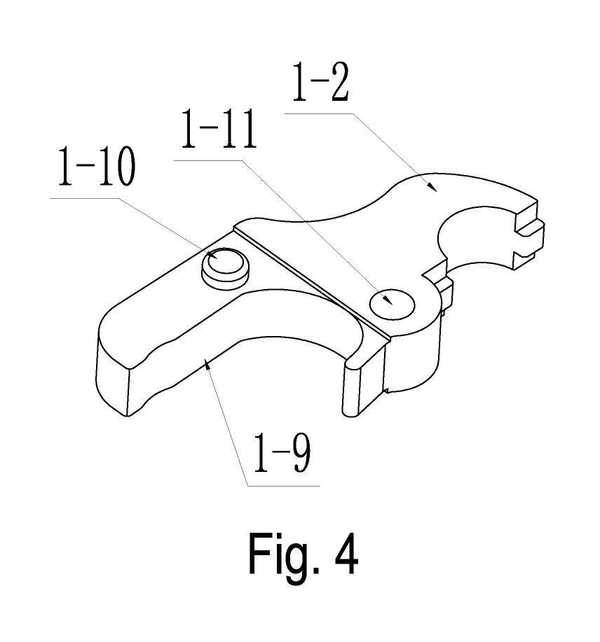

Referring to FIG. 1-4 of the drawings, a press tool with a biased jaw according to a first preferred embodiment of the present invention is illustrated, comprising:
a clamp head portion 1, comprising a fixed clamp head 1-1 and a movable clamp head 1-2; and
a clamp handle portion 2, connected with the clamp head portion 1, comprising a fixed clamp handle 2-1 and a movable clamp handle 2-2.

The the jaw in the clamp head portion is arc.

The fixed clamp head 1-1 has a fixing hole 1-13 provided in one side thereof. The fixed clamp handle 2-1 has a fourth mounting hole 1-14. The fixed clamp head 1-1 is fixedly connected with the fixed clamp handle 2-1 via a fixing pin 1-5 passing through the fixing hole 1-13. The movable clamp handle 2-2 has a first mounting hole 2-9, and is movably connected with the movable clamp head 1-2 via a guiding wheel 2-3, wherein a pin 2-4 passes through the guiding wheel 2-3 and the first mounting hole 2-9, and the guiding wheel 2-3 is rotatable around the pin 2-4.

It is worth mentioning that, the guiding wheel 2-3 is mounted inside the movable clamp handle 2-2, the pin 2-4 passes through the movable clamp head 1-2 and the guiding wheel 2-3.

The fixed clamp head 1-1 and the movable clamp head have a second mounting hole 1-11 provided in a middle thereof for mounting a rotating pin 1-3. The fixed clamp head 1-1 is movably connected with the movable clamp head 1-2 via the rotating pin 1-3 passing through the second mounting hole 1-11. The fixed clamp head 1-1 further has a third mounting hole 1-12 for mounting an eccentric shaft 1-4. The movable clamp handle 2-2 has a fifth mounting hole 2-10. The fixed clamp head 1-1 is movably connected with the movable clamp handle 2-2 via the eccentric shaft 1-4 passing through the third mounting hole 1-12, an opening block ring 1-6, and the fifth mounting hole 2-10.

Sections of the fixed clamp handle 2-1 and the movable clamp handle 2-2 are U-shaped. The fixed clamp handle 2-1 is connected with the movable clamp handle 2-2 via a tension spring fixed leg and a tension spring 2-5, in such a manner that by effect of the tension spring 2-5, the press tool keeps closed when idle. The fixed clamp handle 2-1 comprises a fixed clamp handle glove 2-6, the movable clamp handle 2-2 comprises a movable clamp handle glove 2-7.

The movable clamp head 1-2 has a guiding groove 1-9 for guiding the guiding wheel 2-3, which is curved. A curve of the guiding groove 1-9 is designed according to a size of a pipe fitting that the press tool presses, and changed along with different sizes of different pipe fittings. The fixed clamp head 1-1 comprises a retaining boss 1-7 therein for assisting fixing the fixed clamp handle 2-1, and a shore 1-8 on an edge thereof for preventing transformation during processing and producing. The movable clamp handle 2-2 further comprises two bosses 1-10 on two outer sides thereof for preventing swinging.

The fixed clamp head 1-1 has an inner room for receiving the guiding wheel 2-3 and the guiding groove 1-9. The two bosses 1-10 contact with inner walls of the fixed clamp head 1-1 to provide supporting, so as to prevent swinging when the movable clamp head 1-2 rotates.

When operating the movable clamp handle 2-2, the guiding wheel 2-3 rolls along the guiding groove 1-9 to drive the movable clamp head 1-2. By changing the curve of the guiding groove 1-9, the movable clamp head 1-2 is driven to open for different ranges, so as to adapt for different pipe fittings. It is worth mentioning that, the curve of the guiding groove 1-9 has a length in such a manner that when operating the movable clamp handle 2-2, the guiding wheel 2-3 keeps contacting with the guiding groove 1-9.

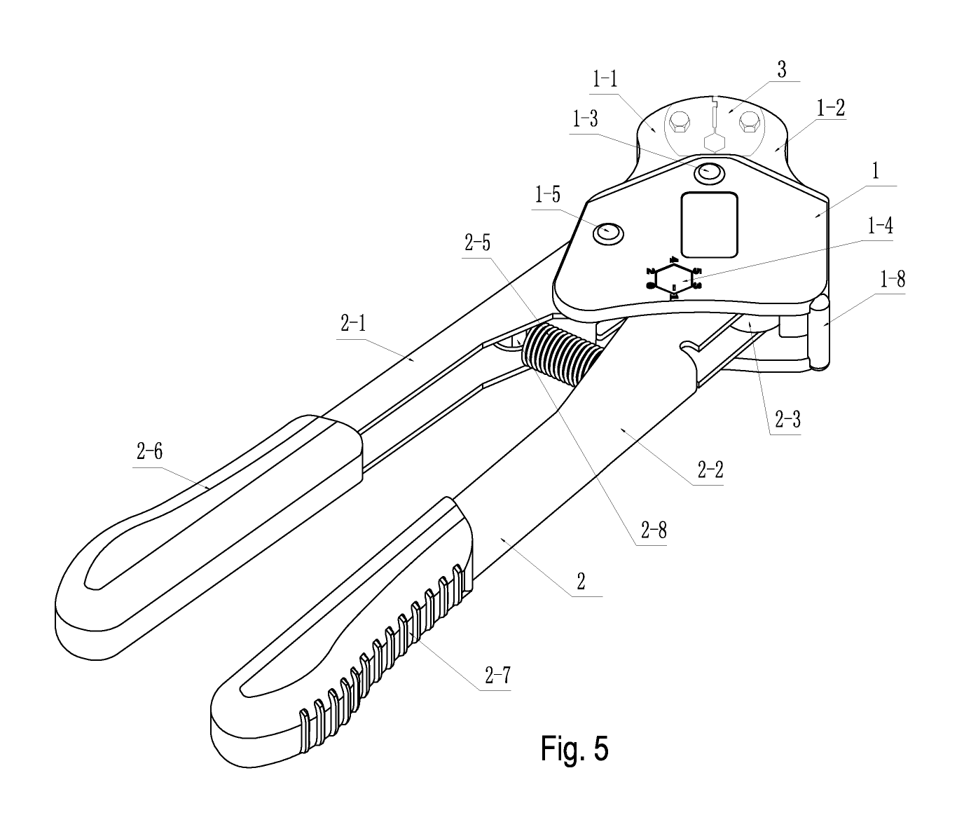

Referring to FIG. 5 of the drawings, a press tool with a biased jaw according to a first preferred embodiment of the present invention is illustrated, comprising:
a clamp head portion 1, comprising a fixed clamp head 1-1 and a movable clamp head 1-2;
a clamp handle portion 2, connected with the clamp head portion 1, comprising a fixed clamp handle 2-1 and a movable clamp handle 2-2; and
a module 3 mounted on the jaw for pressing cables, which is replacable according to sizes of the cables.

The fixed clamp head 1-1 has a fixing hole 1-13 provided in one side thereof. The fixed clamp handle 2-1 has a fourth mounting hole 1-14. The fixed clamp head 1-1 is fixedly connected with the fixed clamp handle 2-1 via a fixing pin 1-5 passing through the fixing hole 1-13. The movable clamp handle 2-2 has a first mounting hole 2-9, and is movably connected with the movable clamp head 1-2 via a guiding wheel 2-3, wherein a pin 2-4 passes through the guiding wheel 2-3 and the first mounting hole 2-9, and the guiding wheel 2-3 is rotatable around the pin 2-4.

It is worth mentioning that, the guiding wheel 2-3 is mounted inside the movable clamp handle 2-2, the pin 2-4 passes through the movable clamp head 1-2 and the guiding wheel 2-3.

The fixed clamp head 1-1 and the movable clamp head have a second mounting hole 1-11 provided in a middle thereof for mounting a rotating pin 1-3. The fixed clamp head 1-1 is movably connected with the movable clamp head 1-2 via the rotating pin 1-3 passing through the second mounting hole 1-11. The fixed clamp head 1-1 further has a third mounting hole 1-12 for mounting an eccentric shaft 1-4. The movable clamp handle 2-2 has a fifth mounting hole 2-10. The fixed clamp head 1-1 is movably connected with the movable clamp handle 2-2 via the eccentric shaft 1-4 passing through the third mounting hole 1-12, an opening block ring 1-6, and the fifth mounting hole 2-10.

Sections of the fixed clamp handle 2-1 and the movable clamp handle 2-2 are U-shaped. The fixed clamp handle 2-1 is connected with the movable clamp handle 2-2 via a tension spring fixed leg and a tension spring 2-5, in such a manner that by effect of the tension spring 2-5, the press tool keeps closed when idle. The fixed clamp handle 2-1 comprises a fixed clamp handle glove 2-6, the movable clamp handle 2-2 comprises a movable clamp handle glove 2-7.

The movable clamp head 1-2 has a guiding groove 1-9 for guiding the guiding wheel 2-3, which is curved. A curve of the guiding groove 1-9 is designed according to a size of a pipe fitting that the press tool presses, and changed along with different sizes of different pipe fittings. The fixed clamp head 1-1 comprises a retaining boss 1-7 therein for assisting fixing the fixed clamp handle 2-1, and a shore 1-8 on an edge thereof for preventing transformation during processing and producing. The movable clamp handle 2-2 further comprises two bosses 1-10 on two outer sides thereof for preventing swinging.

The fixed clamp head 1-1 has an inner room for receiving the guiding wheel 2-3 and the guiding groove 1-9. The two bosses 1-10 contact with inner walls of the fixed clamp head 1-1 to provide supporting, so as to prevent swinging when the movable clamp head 1-2 rotates.

When operating the movable clamp handle 2-2, the guiding wheel 2-3 rolls along the guiding groove 1-9 to drive the movable clamp head 1-2. By changing the curve of the guiding groove 1-9, the movable clamp head 1-2 is driven to open for different ranges, so as to adapt for different pipe fittings. It is worth mentioning that, the curve of the guiding groove 1-9 has a length in such a manner that when operating the movable clamp handle 2-2, the guiding wheel 2-3 keeps contacting with the guiding groove 1-9.

A working mechanism of the present invention is as follows.

When connecting the tubings and the pipe fittings, the tubings and the pipe fittings are connected by inserting connection, the corresponding rings are mounted on the outer wall of the tubings or the fittings, and then the press tool according to the present invention is used to pressing the rings and decrease their diameters to connect the tubings and the pipe fittings tightly. When using the press tool, by operating the clamp handle to open the jaw, holding a connection ring or a cable into the jaw, and then pressing the ring or the cable with the clamp handle, the diameter of the ring is decreased, and the tubings and the pipe fittings are connected tightly, or the cable is pressed to be connected. When the press tool has errors caused by abrasion after overuse, and a pressing force thereof may be insufficient, the eccentric shaft can be adjusted to different positions to enhance the pressing force, so as to accomplish the pressing process.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A press tool with a biased jaw, comprising:
a clamp head portion, comprising a fixed clamp head and a movable clamp head;
a clamp handle portion, connected with said clamp head portion, comprising a fixed clamp handle and a movable clamp handle, wherein said fixed clamp handle is fixedly connected with said fixed clamp handle;
a rotating pin, wherein said fixed clamp head is rotatably connected with said moving clamp head via said rotating pin;
a pin, mounted on said movable clamp handle; and
a guiding wheel, wherein said pin passes through said guiding wheel, said guiding wheel is rotatable around said pin, said movable clamp head has a guiding groove for guiding said guiding wheel, wherein when operating said movable clamp handle, the guiding wheel rolls along the guiding groove to drive the movable clamp head, so that said movable clamp head is movably connected with said movable clamp handle via said guiding wheel and said guiding groove.

2. The press tool, as recited in claim 1, further comprising an eccentric shaft, wherein said fixed clamp head is connected with said movable clamp handle via said eccentric shaft, said eccentric shaft is adjustable to change a press force of the press tool.

3. The press tool, as recited in claim 2, further comprising a tension spring, wherein said fixed clamp handle is connected with said movable clamp handle via said tension spring.

4. The press tool, as recited in claim 3, wherein said guiding groove is curved, and a curve of said guiding groove is corresponding to sizes of pipe fittings or cables that the press tool presses, said movable clamp head is replacable, wherein by changing said curve of said guiding groove, said movable clamp head is driven to open for different ranges, so as to adapt for different pipe fittings, said curve of said guiding groove has a length in such a manner that when operating said movable clamp handle, said guiding wheel keeps contacting with the guiding groove.

5. The press tool, as recited in claim 1, further comprising a module mounted on said jaw for pressing cables.

6. The press tool, as recited in claim 4, further comprising a module mounted on said jaw for pressing cables.

7. The press tool, as recited in claim 6, wherein said module is detachable and replacable according to sizes of the cable.

8. The press tool, as recited in claim 1, wherein said movable clamp handle further comprises two bosses on two outer sides thereof for preventing swinging

9. The press tool, as recited in claim 4, wherein said movable clamp handle further comprises two bosses on two outer sides thereof for preventing swinging

10. The press tool, as recited in claim 8, wherein said fixed clamp head has an inner room for receiving said guiding wheel and said guiding groove, said two bosses contact with inner walls of said fixed clamp head to provide supporting, so as to prevent swinging when said movable clamp head rotates.

11. The press tool, as recited in claim 9, wherein said fixed clamp head has an inner room for receiving said guiding wheel and said guiding groove, said two bosses contact with inner walls of said fixed clamp head to provide supporting, so as to prevent swinging when said movable clamp head rotates.

12. The press tool, as recited in claim 1, wherein said fixed clamp head comprises a retaining boss therein for assisting fixing said fixed clamp handle, and a shore on an edge thereof for preventing transformation during processing and producing.

13. The press tool, as recited in claim 4, wherein said fixed clamp head comprises a retaining boss therein for assisting fixing said fixed clamp handle, and a shore on an edge thereof for preventing transformation during processing and producing.

14. The press tool, as recited in claim 1, wherein sections of said fixed clamp handle and said movable clamp handle are U-shaped.

15. The press tool, as recited in claim 4, wherein sections of said fixed clamp handle and said movable clamp handle are U-shaped.

16. The press tool, as recited in claim 14, wherein said guiding wheel is mounted inside said movable clamp handle, said pin passes through the movable clamp head and said guiding wheel.

17. The press tool, as recited in claim 15, wherein said guiding wheel is mounted inside said movable clamp handle, said pin passes through the movable clamp head and said guiding wheel.

18. The press tool, as recited in claim 1, said fixed clamp handle comprises a fixed clamp handle glove, said movable clamp handle comprises a movable clamp handle glove.

19. The press tool, as recited in claim 4, said fixed clamp handle comprises a fixed clamp handle glove, said movable clamp handle comprises a movable clamp handle glove.

20. The press tool, as recited in claim 11, said fixed clamp handle comprises a fixed clamp handle glove, said movable clamp handle comprises a movable clamp handle glove.
